(19) United States
(12) Patent Application Publication
(10) Pub. No.: US 2012/0259870 A1
(43) Pub. Date: Oct. 11, 2012

(54) METHOD AND SYSTEM FOR ESTABLISHING SORTING ORDER FOR EVENTS

(75) Inventors: Kavi Mahesh, Bangalore (IN); Janivara Kapanipathy Suresh, Bangalore (IN); Rujuswami Daxesh Gandhi, Bhavnagar (IN)

(73) Assignee: INFOSYS TECHNOLOGIES LIMITED, Bangalore (IN)

(21) Appl. No.: 13/314,447

(22) Filed: Dec. 8, 2011

(30) Foreign Application Priority Data
Apr. 7, 2011 (IN) 1195/CHE/2011

(51) Int. Cl. G06F 17/30; G06F 15/16

(52) U.S. Cl. 707/752; 707/E17.033

(57) ABSTRACT

Embodiments of the disclosure relate to a method and system for establishing sorting order for events from a plurality of systems. Central Unique Identity Service (CUIS) provides a unique ID to a client for an event. The client is a service provider registered with the CUIS. User is a subscriber of the client. The User initiates an event with the client using his computing or communication device. The client requests for a unique ID for the initiated event with the CUIS through a network, before the event is performed or executed. The CUIS records the unique ID along with predefined attributes of the client application, the application identifier for the event, application network identity, application user and the user's device associated with the event in the CUIS unit. The CUIS thus establishes a sorting order for the unique ID's recorded and thereby for the events across all clients.

This application claims the benefit of Indian Patent Application Filing No. 1195/CHE/2011, filed Apr. 7, 2011, which is hereby incorporated by reference in its entirety.

### TECHNICAL FIELD

Embodiments of the present disclosure relate to sorting of events. More particularly, the embodiments relate to a method and a system for establishing sorting order for events across systems.

### BACKGROUND

Presently, relational database systems use primary key and foreign key to uniquely identify an entity or a data record within a single database. In some databases, such sequence numbers are unique only for a given system or application. For example, Microsoft SQL Server has the concept of an identity column in a table, which can automatically assign a unique sequence number to rows within that table. While in others, sequence numbers can be unique across entities, as in Oracle, for example, where a sequence object can be invoked to obtain a unique sequence number that can be inserted into any table while inserting or updating a row in that table. However, there is no mechanism to assign a unique sequence number across different databases.

Another concept is of using globally unique id or GUID, which is generated typically using the MAC address of a computer along with serial numbers or other identifiers of peripheral devices in addition to the system time of that computer. However, since the clocks of all the computers in the world are not synchronized, it is not possible to sort such GUIDs precisely in a chronological order to establish a sorting order across all online events in the world.

Yet another concept that is presently available is a method for assigning a unique sequence number to database transactions. However, the method appears to be limited to a single database and is not applicable to transactions that happen independently across disparate online sources or services. Also, the method focuses more on optimizing the throughput of database transactions by not locking the database during a transaction for the purposes of obtaining a unique sequence number, rather than on establishing chronological sorting orders on transactions that happen in different databases over the internet or any other network.

Therefore, it is clear that there is no technology in the prior art that can be applied to establish a globally unique and accurate sorting order across on-line events occurring or originating from multiple computing servers, such as email services, social networking sites, bank ATMs, on-line brokerage houses, etc.

### SUMMARY

The shortcomings of the prior art are overcome and additional advantages are provided through the provision of a method and system as described in the description.

The present disclosure solves the limitations of existing techniques by assigning a globally unique identifier to an event or transactions across different systems.

In one embodiment, the disclosure provides a method for establishing sorting order for events from a plurality of systems comprising acts of requesting for a unique identifier for an event from a Central Unique Identity Service (CUIS) unit by a client. The client receives the unique identifier from the CUIS unit before the start of the event. The CUIS records the unique identifier along with predefined attributes of the client application, application identifier for the event, application network identity, application user and the user's device associated with the event in the CUIS unit. Thus, the CUIS establishes the sorting order for the unique identifiers recorded and thereby the events, based on predefined attributes.

In another embodiment, the disclosure provides a system to establish sorting order for events from plurality of systems comprising Central Unique Identity Service (CUIS) unit to provide a unique identifier to a client for an event. The CUIS consists of the means to record the unique identifier along with predefined attributes of client application, application identifier for the event, application network identity, application user and the user's device associated with the event in the CUIS unit. Further, the system comprises a computing device comprising a processor responsible for establishing sorting order of the unique identifiers recorded in the CUIS unit and thereby the events, based on predefined attributes.

### BRIEF DESCRIPTION OF THE ACCOMPANYING FIGURES

The novel features and characteristics of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures in which:

FIG. 1 illustrates an exemplary block diagram of a system for establishing sorting order of events across different systems, in accordance with one embodiment.

FIG. 2 is a flowchart illustrating a method for establishing sorting order of events across different systems, in accordance with one embodiment.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of Figures is provided for the purpose of illustration and description only and is not intended as a definition of the limits of the present disclosure.

Exemplary embodiments of the present disclosure provide a method and a system for establishing a sorting order for events across different systems.

In one embodiment, the disclosure provides a means for the creation of a central system for the generation of unique IDs to collate events across diverse, unconnected sources and services. Also, to constitute a mechanism to aggregate and disaggregate the chronology or transactional details of a dynamically determined sub-set of events in said sources and services that may be defined at any time before or after the events occur.

In one embodiment, the disclosure provides the ability to establish a globally unique and accurate chronological sorting order across all on-line events in different servers and services. Establishing the sorting order is essential for a variety of applications in information security, massively collaborative on-line gaming, distributed auctions, detection and prevention of financial frauds such as money laundering etc.

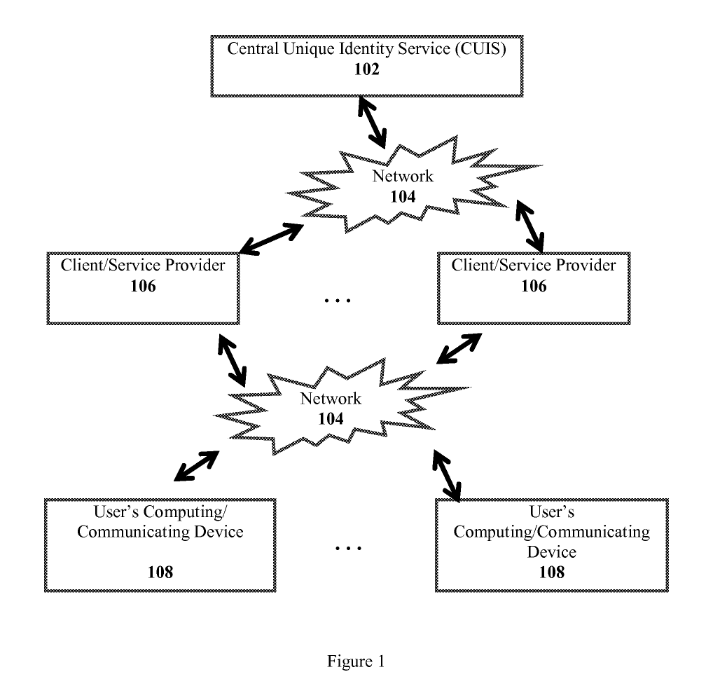

FIG. 1 illustrates an exemplary block diagram of a system to establish sorting order for events from a plurality of systems 100. As shown in FIG. 1, the system comprises a Central Unique Identity Service (CUIS) 102 to provide a unique ID (identifier) to a client 106 for an event. The client is a service provider registered with the CUIS. User is a subscriber of the client. The User initiates an event with the client using his computing device 108. The client 106 immediately requests for a unique ID for the initiated event with the CUIS 102 through a network 104, before the event is performed or executed. The user may or may not be aware of the request for the unique ID. The CUIS 102 has a recording or storage means to record the unique ID along with predefined attributes of the client application, its identifier for the event, its network identity, its user and the user's device associated with the event. The CUIS 102 provides the recorded information to authorized agencies or governments to enable the establishment of a sorting order.

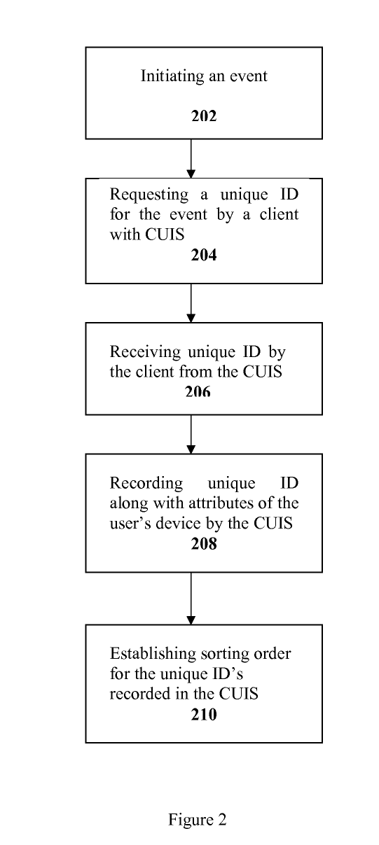

FIG. 2 is a flowchart illustrating a method for establishing a sorting order for events across a plurality of systems or sources, in accordance with an exemplary embodiment. The method comprises the following steps:

At step 202, the user initiates an event with a client. The client is a service provider of the event. The event is selected from at least one of electronic mail, instant messaging, texting, telephonic call, social network communication, access control, sensory data capture, online gaming, digital photography, blog posting, electronic commerce, banking and financial transaction services.

Central Unique Identity Service (CUIS) provides an autonomous, central, globally unique identity service. The CUIS receives a request for a unique id from any registered client for an event which is shown in step 204 of FIG. 2; wherein the client is a service provider registered with the CUIS.

The CUIS responds to the request with a globally unique identifier comprising a unique sequence number which is received by the client as shown in step 206 of FIG. 2.

The CUIS records the issuance of each identifier along with the client name, the date and time stamp of the request and any other relevant data provided by the client such as its own identifier for the event and the IP address of the user's device or machine as shown in the step 208 of FIG. 2.

The CUIS upon request provides data about already issued identifiers to authorized agencies such as governments.

The authorized agencies or the CUIS server itself establish a sorting order by arranging the set of identifiers chronologically using their date and time stamps or in terms of other parameters such as the sequential numbers of the unique identifiers and optionally by filtering the set of identifiers using any parameter such as the client service to whom the identifier was issued, as shown in the step 210 of FIG. 2.

The clients 106 are service providers. The services of the service provider include but are not limited to an electronic mail, instant messaging, texting, telephonic call, social network communication, access control, sensory data capture, online gaming, digital photography, blog posting, electronic commerce, banking and financial transaction services. The clients 106 are registered with the CUIS 102. The registering of clients is either voluntary or under government mandate. The client obtains a unique ID for every transaction or activity before the start of the transaction or activity. The CUIS records the unique ID. Authorized agencies and government can obtain data about issued unique IDs from the CUIS for a given period of time or in the proximity of a given ID.

Applications of the present disclosure include but are not limited to enabling distributed massive on-line auctions and on-line gaming; detecting and preventing financial frauds such as money laundering, round-tripping and front-running; establishment of alibi; reconstructing forensic footprints and event sequences around significant happenings; and aggregating financial behaviours and credit ratings across agencies.

In another embodiment, the technology disclosed in the present disclosure provides a better method for solving the problem of tracking click-through revenues based on sales resulting from on-line advertisements. The actions of any customer after clicking on an on-line advertisement can be tracked efficiently using the CUIS by the service provider or a neutral and trusted third-party. The click-through revenues are directly mapped with the actual purchase or other service transaction resulting from the click. In addition, any agency that prevents or retards the completion of such a business transaction, as for example, banking or credit card payment gateway that rejects a sales approval due to peak loads or other reasons can now be penalized by both the advertiser and the seller or service provider by way of seeking compensation for the failed transaction.

On-line advertisers pay the advertising agency for displaying their ads but often only when a customer clicks on their ads. However, once the customer clicks on the ad and leaves the advertiser's site, there is no efficient mechanism in the prior art to determine whether any sale or other benefit actually resulted from the advertisement.

The method provided in the disclosure can be applied to provide a solution to the above problem as follows:

When a customer clicks on a displayed advertisement link, the advertisement service obtains a unique ID for the event. The service also sends the unique ID so obtained to the advertiser's page using HTTP Post method, for example.

The advertiser or seller captures the unique ID thus obtained from the source page on which the advertisement was displayed. Subsequently, if the customer purchases any product or service from the page, the advertiser obtains further unique IDs from the CUTS for completing the customer's transaction.

If payment for the on-line transaction is done through a payment gateway or on-line bank or credit card, the seller provides the unique ID along with other transaction information to the payment gateway. The payment gateway in turn will obtain a unique ID for the financial transaction and send it back to the seller.

The advertiser can now bill the seller for each click-through along with relevant unique IDs. The seller can establish a mapping between these unique IDs and the unique IDs of any resulting transaction as well as the unique ID of the consequent financial transaction provided by the payment gateway and also verify the chronological or other sorting order of all the unique IDs involved. The seller can pay the advertising charges to the advertiser depending on the revenue generated from verified sales transactions.

In the event that, a payment gateway or other service provider e.g., dispatching or courier service prevents the sales transaction from being completed e.g., due to excessive loads on their services, both the advertiser and the seller can seek punitive damages from the failed service provider, again after establishing the ordering of the relevant unique IDs.

In yet another embodiment, the technology disclosed in the present disclosure provides a solution for solving crimes by establishing a reliable chronological sequence for events as they occur across systems. For example, consider a crime related to stock manipulation wherein heavy selling was noticed just before a public statement was released to the media by a company that led to a crash in its stock. Investigators suspect that the heavy selling was orchestrated by using insider information about the company performance. Further investigation revealed that a coded message was posted, just before the sell-off, on a popular social networking site by someone whose relative received a text message from an insider in the company. However, this evidence may not be admissible in a court of law without the aid of the invention in the present disclosure because the order of the above events cannot be established with legal certainty (e.g., the person who posted the message on the social networking site could claim that he did it before getting the call from his relative; the relative in turn could claim that he made the call before he received any text message from the insider). With the present disclosure, wherein all the service providers such as the social networking site and the text messaging service are registered clients of the CUTS, a chronological sequence of these events can be established with certainty thereby helping the investigators solve the crime.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for establishing a sorting order for events from a plurality of systems comprising acts of:
requesting for a unique identifier for an event from a Central Unique Identity Service (CUIS) unit by a client;
receiving the unique identifier from the CUIS unit by the client before start of the event;
recording the unique identifier along with predefined attributes of the client application, application identifier for the event, application network identity, application user and the user's device associated with the event in the CUIS unit; and
establishing sorting order for the unique identifiers recorded in the CUIS unit and thereby for the events, based on predefined attributes.

2. The method as claimed in claim 1, wherein the systems are computing devices selected from at least one of mobile phones, computer systems, databases and Personal Digital Assistants (PDA).

3. The method as claimed in claim 1, wherein the unique identifier is a unique sequence number.

4. The method as claimed in claim 1, wherein the event is selected from at least one of electronic mail, instant messaging, texting, telephonic call, social network communication, access control, sensory data capture, online gaming, digital photography, blog posting, electronic commerce, banking and financial transaction services.

5. The method as claimed in claim 1, wherein each client receives the unique identifier for every event.

6. The method as claimed in claim 1, wherein the client records the unique identifier in its usage, transaction or event logs.

7. The method as claimed in claim 1, wherein the predefined attributes are selected from at least one of type of event, user's name, date and time stamps of the request, IP address of the user's device and MAC address of the user's device.

8. The method as claimed in claim 1, wherein the client is a service provider for an event registered with the CUIS.

9. A system to establish a sorting order for events comprising:
Central Unique Identity Service (CUIS) unit to provide a unique identifier to a client for an event;
recording means to record the unique identifier along with predefined attributes of the client application, application identifier for the event, application network identity, application user and the user's device associated with the event into the CUIS unit; and
a computing device comprising a processor responsible for establishing sorting order for the unique identifiers recorded in the CUIS unit and thereby for the events, based on predefined attributes.

10. The system as claimed in claim 9, wherein the event is selected from at least one of electronic mail, instant messaging, texting, telephonic call, social network communication, online gaming, digital photography, blog posting, access control, sensory data capture, electronic commerce, banking and financial transaction services

11. The system as claimed in claim 9, wherein the client is a service provider for an event registered with the CUIS.

12. The system as claimed in claim 9, wherein the events are initiated from a user's system.

13. The system as claimed in claim 12, wherein the user's system is a computing and communication device selected from at least one of mobile phones, personal digital assistants (PDA), digital cameras, computer systems, databases, computer peripherals, digital tablets, Micro Electro-Mechanical Sensors (MEMS), medical care and health monitoring systems, automated toll and ticket booths, point of sale devices (PoS), access control systems, RFID systems, GPS devices, electronic security systems and automated teller machines (ATM).
